(19) United States
(12) Patent Application Publication
(10) Pub. No.: US 2008/0115065 A1
(43) Pub. Date: May 15, 2008

(54) Data tree structure display and navigation method and system

(75) Inventor: Steve Gunnar Bjorg, San Diego, CA (US)

Correspondence Address: SCHWEGMAN, LUNDBERG & WOESSNER, P.A., P.O. BOX 2938, MINNEAPOLIS, MN, 55402, US

(73) Assignee: Mindtouch

(21) Appl. No.: 11/600,706

(22) Filed: Nov. 15, 2006

(51) Int. Cl. G06F 3/00

(52) U.S. Cl. 715/745

(57) ABSTRACT

Embodiments for displaying and navigating electronic data tree structures are described generally herein. Other embodiments may be described and claimed.

### TECHNICAL FIELD

Various embodiments described herein relate generally to data tree structures and navigation, including apparatus, systems, and methods used in displaying and navigating electronic data trees.

### BACKGROUND INFORMATION

Electronic data may be organized, viewed, or stored in a tree format or structure. A user may want to display and navigate such electronic data tree structures.

### BRIEF DESCRIPTION OF THE DRAWINGS

FIG. 1 is a system diagram of an electronic data tree structure display and navigation architecture according to various embodiments.

FIG. 2A illustrates a computer system in which an electronic data tree structure display and navigation application resides according to various embodiments.

FIGS. 2B to 2K illustrates electronic data tree structure display and navigation application displays according to various embodiments.

FIG. 3 illustrates an electronic data tree structure according to various embodiments.

FIG. 4 is a flow diagram illustrating several methods according to various embodiments.

FIG. 5 is a block diagram of an article according to various embodiments.

FIG. 6 is a block diagram of an article according to various embodiments.

### DETAILED DESCRIPTION

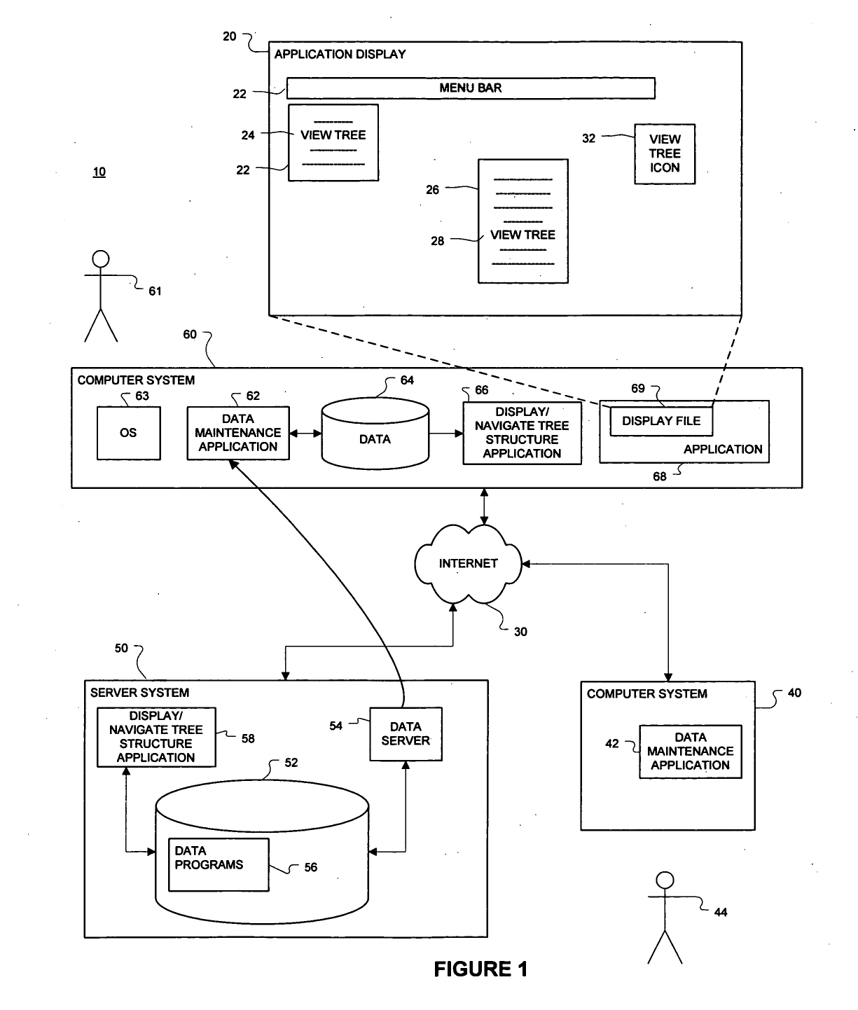

FIG. 1 is a system diagram of an electronic data tree structure display and navigation architecture 10 including a computer system 60, a server system 50, and a computer system 40 coupled to a network 30 (e.g., the Internet). The computer system 60 may be coupled to the server system 50 via a network 30 (e.g., the Internet). The computer system 40 may be coupled to the server system 50 via the network 30. A viewing user 61 may utilize the computer system 60 to view an application display 20. The computer system 60 may also host an electronic data tree structure display and navigation application 66 or 58 where a viewing user 61 may effectively invoke the application 66 via one or more icons or items 24, 28, 32 to generate and display an electronic data tree structure.

In an embodiment the icon or item 24 may be part of a menu entry 22 from an application menu 20. The icon or item 28 may be part of a pop up menu 26 that may be invoked by the application 68 or the computer system 60 operating system (OS) application 63, such as Linux®, Windows®, Vista®, or OS X®. The icon or item 32 may be an application 68 add-in that when selected invokes an electronic data tree structure display and navigation application 66 or 58. In an embodiment an icon or item 24, 28, 32 selection may generate an electronic data tree structure display and navigation request that is forwarded to predetermined uniform resource locator (URL). The URL may designate the application 66 or 58 and include an indication of the requesting user 61 or computer system 60.

The electronic data tree structure display and navigation application 66 may operate to generate a tree structure representative of electronic data and enable a user to navigate the tree structure. The application 68 may create the display file 69 to enable a viewing user 61 to process at least a segment of data that may be represented by the tree structure created by the application 66 or 58 upon an icon or item 24, 28, 32 selection. The application 68 may be a word processing, a presentation, a publication, a spreadsheet, web page application, operating system application, or a related data processing application.

Upon selection of an icon or item 24, 28, 32, the electronic data tree structure display and navigation application 66 (hosted by the computer system 60) or 58 (hosted by server system 50) may be invoked (such as by a URL call). The electronic data tree structure display and navigation application 66 may generate a tree structure representative of electronic data stored in a database or file system 64, 52. The data 64, 52 may be stored in a tree structure and the application 66 may generate a user perceptible representation of the data tree structure. The application 66 may also enable a user to select navigate the tree structure by selecting one or more items or sections in the tree.

In an embodiment, the computer system 60 may host an electronic data or file system database 64 and a data maintenance application 62 where the application 62 may be an operating system 63 application including a file directory maintenance application. In an embodiment the viewing user 61 may be able to maintain the data 64 or data 56 via the OS 63 or data maintenance application 62. The viewing user 44 may be able to maintain data 64, 56 via a data maintenance application 42.

The data maintenance application 62 may receive data modification requests for data 64 from the server system 50 via the network 30. The server system 50 may include a data server 54 and database 52. The database 52 may include data and programs 56. The computer system 40 may host the data maintenance application 42. The viewing user 44 may utilize the data maintenance application 42 to generate or maintain data in the database 52 via the network 30.

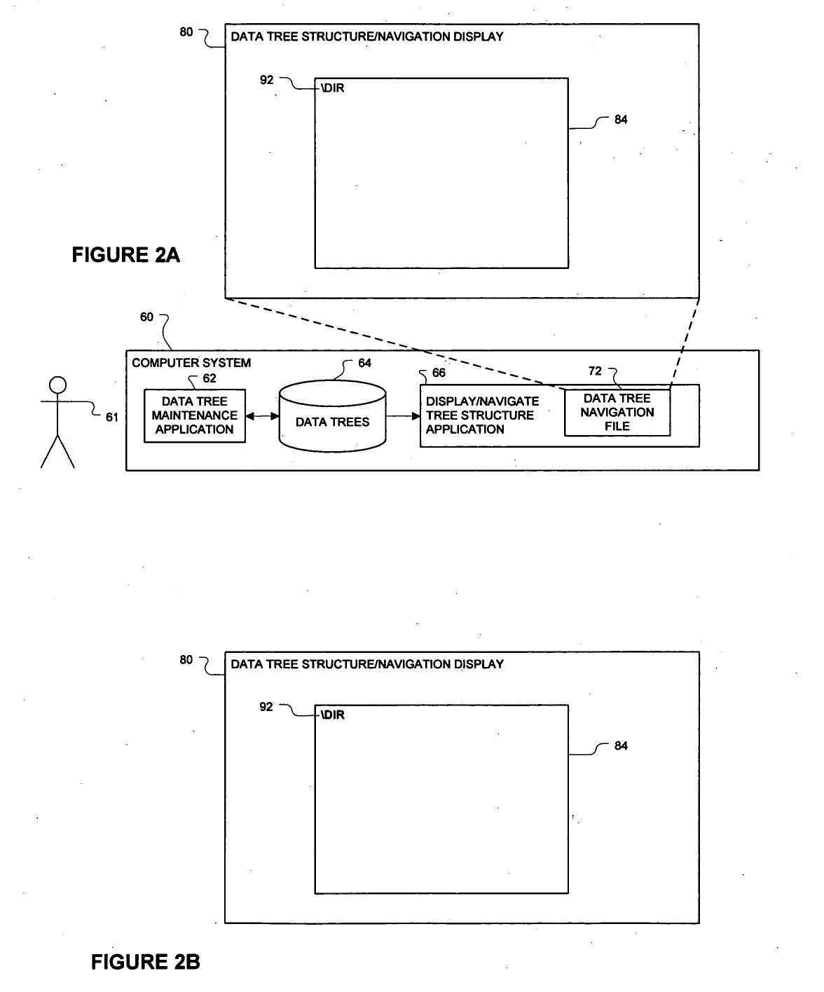

The electronic data tree structure display and navigation application 66 or 58 may create a data tree structure navigation file 72 to be shown on the data tree structure/navigation display 80. In an embodiment the computer system 600S 63 or application 68 document generation plug-in may generate the data tree structure/navigation display 80. The display may be a window or segment within another display in an embodiment. The electronic data tree structure display and navigation application 66 or 58 may retrieve a tree representing data or process data to generate a tree representative of the data upon icon or item 24, 28, 32 selection by a viewing user 61 where a section (designated section) of the tree to be generated may be indicated by the icon or item. A default designed section may be implied by an icon or item selection in an embodiment such as the root or top level directory (\DIR 92 in FIG. 2A). The data may represent files and folders in a directory structure or other data that may be represented in a tree structure.

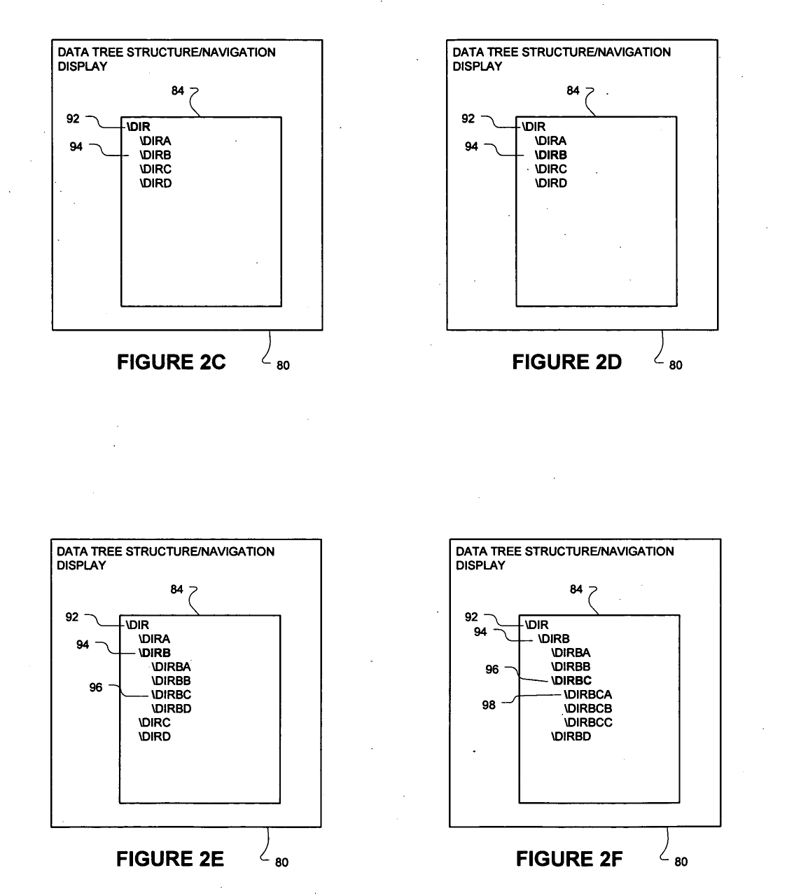

FIG. 3 is an example of a tree structure 84 that represents file directories and subdirectories. In an embodiment a user 61 may select the top level directory 92 of the directory tree 84 (shown in FIG. 2A). In an embodiment as the directory tree is navigated only the siblings, direct decedents, and antecedents, i.e., parent, grand-parent, great-grand-parent, etcetera to the root, of a current tree element (directory in FIGS. 2A to 3) are shown (from a genealogical view). Various graphics 112, 114, 116, 118 (in FIG. 2K) and offsets (FIGS. 2A to 2J) may be employed to distinguish tree sections or lineage.

The electronic data tree structure display and navigation application 66 or 58 may use various offsets, graphics, and genealogical views based on the user 61, the requesting computer system 60, or the requesting application 68. In an embodiment a user may specify that siblings are not shown, for example. FIGS. 2A to 2H depict tree structure/navigation displays 80 for a user navigating from \DIR, \DIRB, \DIRBC, \DIRBCA, \DIRBCAB, to \DIRBCABB. In detail when \DIR 92 (the tree root) is selected (FIG. 2B—\DIR highlighted) the electronic data tree structure display and navigation application 66 or 58 may generate a new tree navigation file 72 that includes the direct decedents, siblings, and antecedents. For the directory structure 84, the direct decedents \DIRA, \DIRB, \DIRC, and \DIRD may be shown (FIG. 2C).

The user 61 may then select \DIRB. The electronic data tree structure display and navigation application 66 or 58 may generate a new tree navigation file 72 that highlights the selected directory \DIRB 94 (FIG. 2D) and then another that includes the direct decedents, siblings, and antecedents for the selection (FIG. 2E). Similarly when a user 61 selects \DIRBC 96 in electronic data tree structure shown in FIG. 2E, the navigation application 66 or 58 may generate a new tree navigation file 72 that includes the direct decedents, siblings, and antecedents for the selection (FIG. 2F). As shown in FIG. 2F, \DIRA, \DIRC, and \DIRD are not shown (not antecedents).

When a user 61 selects \DIRBCA 98 in the electronic data tree structure shown in FIG. 2F, the display and navigation application 66 or 58 may generate a new tree navigation file 72 that includes the direct decedents, siblings, and antecedents for the selection (FIG. 2G). As shown in FIG. 2G, \DIRBA, \DIRBB, and \DIRBD are not shown (not antecedents). Similarly, when a user 61 selects \DIRBCAB 102 in the electronic data tree structure 84 shown in FIG. 2G, the display and navigation application 66 or 58 may generate a new tree navigation file 72 that includes the direct decedents, siblings, and antecedents for the selection (FIG. 2H). As shown in FIG. 2H, \DIRBCB and \DIRBCC are not shown (not antecedents).

In an embodiment the electronic data tree structure display and navigation application 66 or 58 may generate a new tree navigation file 72 that includes only up to a predetermined of nearby siblings, e.g., the file 72 may include only up to the six closest siblings. Similarly, the electronic data tree structure display and navigation application 66 or 58 may generate a new tree navigation file 72 that includes only up to a predetermined of direct decedents, e.g., the file 72 may include only up to six direct decedents (for the top of the list of direct decedents in an embodiment).

When a user 61 wants to navigate to another section currently not shown, such as \DIRA, a user 61 may select the sibling shown in the current tree (\DIRB). When a user 61 selects \DIRB 94 the electronic data tree structure display and navigation application 66 or 58 may generate a new tree navigation file 72 that includes only the direct decedents, siblings, and antecedents for the selection (FIG. 2I). As shown in FIG. 2I, the directories shown previously in FIG. 2H have been collapsed. A user 61 may then select a sibling such as \DIRA and the electronic data tree structure display and navigation application 66 or 58 may generate a new tree navigation file 72 that includes only the direct decedents, siblings, and antecedents for the selection (FIG. 2J).

As noted the tree structure display 80 may include offset and graphics that may be employed to distinguish tree sections or lineage. FIG. 2K includes a display 80 that includes graphics 112, 114, 116, and 118 to distinguish various tree sections. Graphic 112 indicates the root, home, or designated section 92. Graphic 114 indicates that the sections around the graphic are antecedents, e.g. between 92 and 94. The graphic 118 indicates that the sections are direct decedents of an above section (102). The selected section 102 may also be highlighted (boxed) in an embodiment.

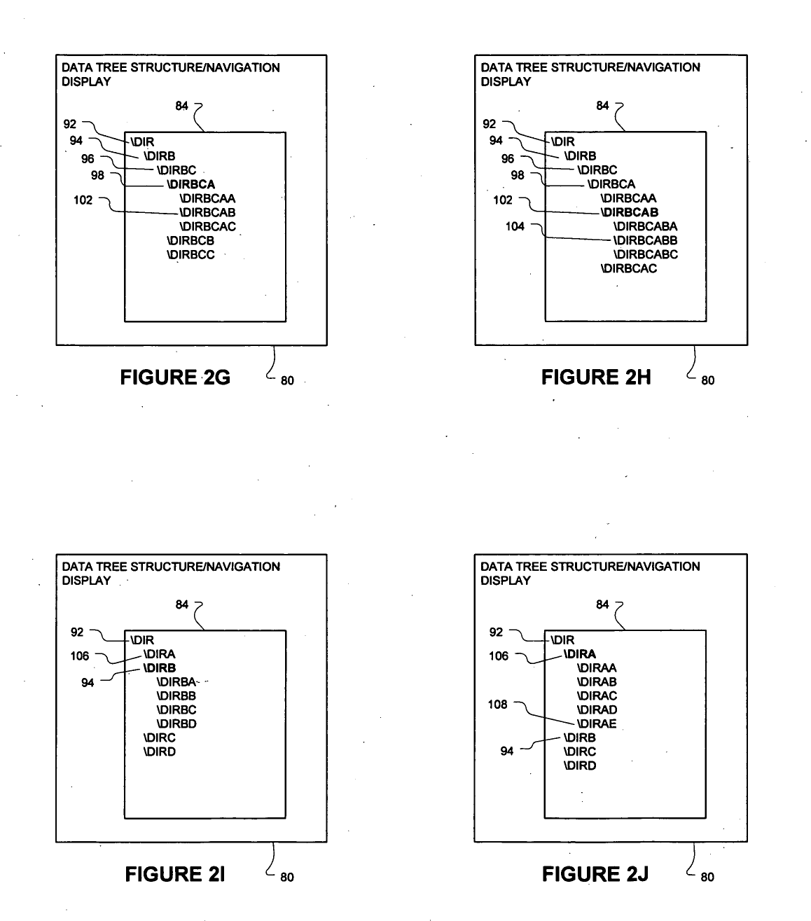

FIG. 4 is a flow diagram of an electronic data tree structure generation and display method 190 according to various embodiments. In the method 190 when a user (such as viewing user 61) generates an electronic data tree display or navigation request via the icon or list 24, 28, 32 (activity 192), the method 190 may generate and display a tree for selected data as a function of the requesting user 61, the application 68, or the computer system 60 (activity 194). The method 190 may retrieve user, application, or computer system specific or independent tree structure preferences and apply such preferences to the selected data. In the method 190 the electronic data tree structure display and navigation application 66 or 58 may generate a tree navigation file 72 to be displayed that includes the direct decedents, siblings, and antecedents for the current tree section.

Upon detection of user selection of a new tree section from the displayed tree structure (activity 196), the method 190 may review the current tree structure based on the selected section (activity 198). When extra or missing branches (sections) are detected (activity 202), the method 190 may add or collapse branches or sections based on determined preferences (activity 204). The method 190 may then generate and display the updated tree structure (activity 206).

In an embodiment the method 190 generates a tree navigation file 72 to be displayed that includes the direct decedents, siblings, and antecedents for the tree whenever a section is selected (activity 196). The updated tree navigation file 72 may then be displayed (activity 206).

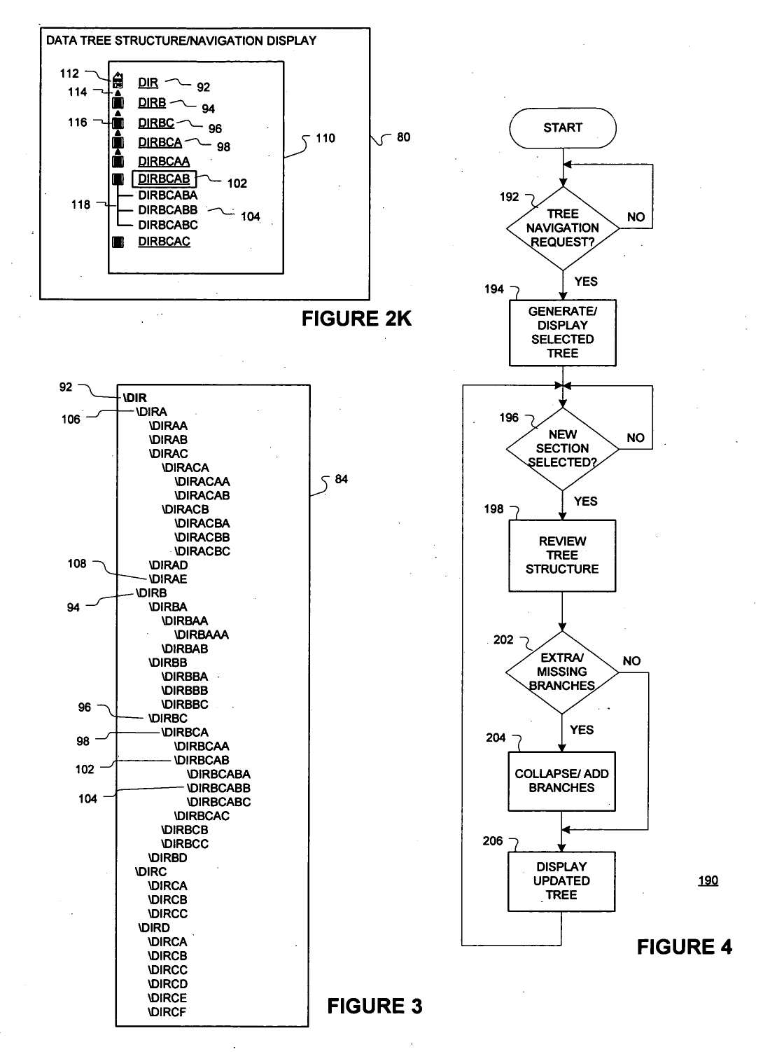

A device 260 is shown in FIG. 5 that may be used in various embodiments as a computer system 60 or computer system 40 where the device may be any computing device including a personal data assistant, cellular telephone, laptop computer, or desktop computer. The device 260 may include a central processing unit (CPU) 262, a random access memory (RAM) 264, a read only memory (ROM”) 266, a display 268, a user input device 272, a transceiver application specific integrated circuit (ASIC) 274, a microphone 288, a speaker 282, and an antenna 284.

The CPU 262 may include an OS module 294 and an application module 292. The RAM 264 may include a queue 278 where the queue 278 may store the tree structure and tree navigation file 72. The OS module 294 and the application module 292 may be separate elements. The OS module 294 may execute the computer system 600S 63. The application module 292 may execute the electronic data tree structure display and navigation application 66, application 68, the data maintenance application 62, or the data maintenance application 42.

The ROM 266 is coupled to the CPU 262 and may store the program instructions to be executed by the CPU 262, OS module 294, and application module 292. The RAM 264 is coupled to the CPU 262 and may store temporary program data, overhead information, and the queues 278. The user input device 272 may comprise an input device such as a keypad, touch pad screen, track ball or other similar input device that allows the user to navigate through menus in order to operate the device 260. The display 268 may be an output device such as a CRT, LCD or other similar screen display that enables the user to read, view, or hear tree structures 84, 110.

The microphone 288 and speaker 282 may be incorporated into the device 260. The microphone 288 and speaker 282 may also be separated from the device 260. Received data may be transmitted to the CPU 262 via a serial bus 276 where the data may include messages or pages received, messages or pages to be transmitted, or protocol information. The transceiver ASIC 274 may include an instruction set necessary to communicate data, screens, or documents in architecture 10. The ASIC 274 may be coupled to the antenna 284 to communicate wireless messages or pages within the architecture 10. When a message is received by the transceiver ASIC 274, its corresponding data may be transferred to the CPU 262 via the serial bus 276. The data can include wireless protocol, overhead information, and data to be processed by the device 260 in accordance with the methods described herein.

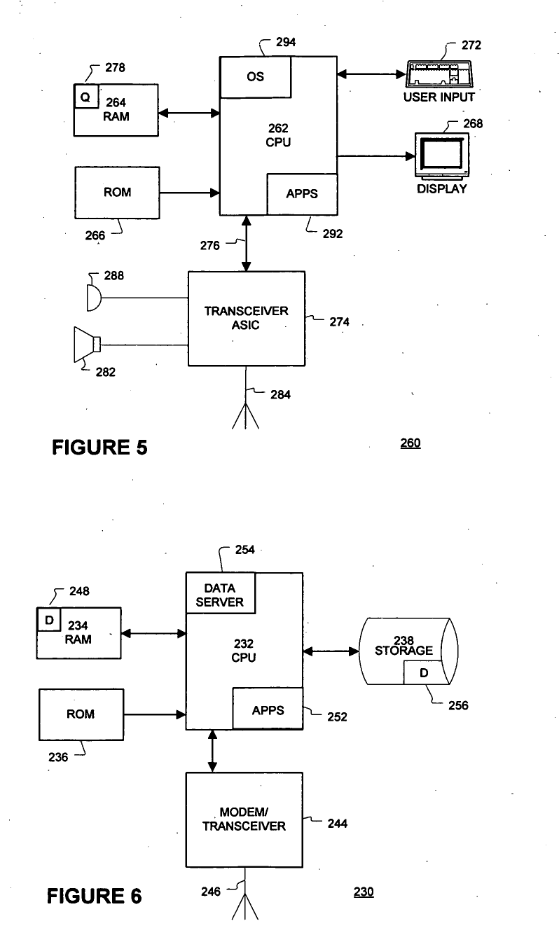

FIG. 6 illustrates a block diagram of a device 230 that may be employed as a server system 50 in various embodiments. The device 230 may include a CPU 232, a RAM 234, a ROM 236, a storage unit 238, a modem/transceiver 244, and an antenna 246. The CPU 232 may include a data server module 254 and an application module 252. In an embodiment, the application module 252 may execute the electronic data tree structure display and navigation application 58. The RAM 234 may include a database 248 where the database 248 may be used to store the data 56. The storage 238 may also include a database 256 where the database 256 may be used to store the tree structure and tree navigation file 72. The data server module 254 and an application module 252 may be separate elements.

The modem/transceiver 244 may couple, in a well-known manner, the device 230 to the network 30 or POTS to enable communication in the network 10. In an embodiment, the modem/transceiver 244 may be a wireless modem or other communication device that may enable communication with the computer system 60 or the computer system 40. The ROM 236 may store program instructions to be executed by the CPU 232, data server module 254, or application module 252. The RAM 234 may be used to store temporary program information, queues, databases, and overhead information. The storage device 238 may comprise any convenient form of data storage and may be used to store temporary program information, queues, databases, and overhead information.

Any of the components previously described can be implemented in a number of ways, including embodiments in software. Thus, the CPU 232, data server module 254, application module 252, modem/transceiver 244, antenna 246, storage 238, RAM 234, ROM 236, database 248, database 256, CPU 262, OS module 292, application module 294, transceiver ASIC 274, antenna 284, microphone 288, speaker 282, ROM 266, RAM 264, queue 278, user input 272, display 268, computer system 60, computer system 40, and server system 50 may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A system, including:
a first application module to generate an electronic tree structure having a first plurality of sections based on electronic data and a designated section, the tree structure including only the direct decedents, siblings, and antecedents of the designated section.

2. The system of claim 1, further including a second application module to enable a user to select one of the first plurality of tree structure sections and a third application module to generate an electronic tree structure having a second plurality of sections based on electronic data and a user selected section of the first plurality of sections, the tree structure including only the direct decedents, siblings, and antecedents of the user selected section.

3. The system of claim 1, further including a fourth application module to display the generated electronic tree structure.

4. The system of claim 1, wherein the tree structure includes only up to a predetermined number of siblings.

5. The system of claim 3, wherein the generated electronic tree structure includes at least one graphic, the graphic indicating the relationship between at least two sections of the first plurality of tree structure sections.

6. The system of claim 1, wherein the electronic data includes a file directory.

7. The system of claim 1, wherein the electronic data includes a relational database.

8. A method, comprising:
generating an electronic tree structure having a first plurality of sections based on electronic data and a designated section, the tree structure including only the direct decedents, siblings, and antecedents of the designated section.

9. The method of claim 8, further comprising enabling a user to select one of the first plurality of tree structure sections and generating an electronic tree structure having a second plurality of sections based on electronic data and a user selected section of the first plurality of sections, the tree structure including only the direct decedents, siblings, and antecedents of the user selected section.

10. The method of claim 8, further comprising displaying the generated electronic tree structure.

11. The method of claim 8, wherein the tree structure includes only up to a predetermined number of siblings.

12. The method of claim 10, wherein the generated electronic tree structure includes at least one graphic, the graphic indicating the relationship between at least two sections of the first plurality of tree structure sections.

13. The method of claim 8, wherein the electronic data includes a file directory.

14. The method of claim 8, wherein the electronic data includes a relational database.

15. An article including a machine-accessible medium having associated information, wherein the information, when accessed, results in a machine performing:
generating an electronic tree structure having a first plurality of sections based on electronic data and a designated section, the tree structure including only the direct decedents, siblings, and antecedents of the designated section.

16. The article of claim 15, wherein the information, when accessed, results in a machine further performing enabling a user to select one of the first plurality of tree structure sections and generating an electronic tree structure having a second plurality of sections based on electronic data and a user selected section of the first plurality of sections, the tree structure including only the direct decedents, siblings, and antecedents of the user selected section.

17. The article of claim 15, wherein the information, when accessed, results in a machine further performing displaying the generated electronic tree structure.

18. The article of claim 15, wherein the tree structure includes only up to a predetermined number of siblings.

19. The method of claim 15, wherein the electronic data includes a file directory.

20. The method of claim 15, wherein the electronic data includes a relational database.
